(19) United States
(12) Patent Application Publication
(10) Pub. No.: US 2001/0036397 A1
(43) Pub. Date: Nov. 1, 2001

(54) Pressure switch to defeat platform fold operation in a hydraulic lift

(76) Inventors: James R. Pierrou, Winamac, IN (US); Jeffrey J. Hermanson, Culver, IN (US)

Correspondence Address: Woodard, Emhardt, Naughton,, Moriarty and McNett, Bank One Center/Tower, 111 Monument Circle, Suite 3700, Indianapolis, IN, 46204-5137, US

(21) Appl. No.: 09/886,680

(22) Filed: Jun. 21, 2001

Related U.S. Application Data
(63) Continuation of application No. 09/430,436, filed on Oct. 29, 1999, now abandoned.
(60) Provisional application No. 60/106,365, filed on Oct. 30, 1998.

(51) Int. Cl. B60P 1/44

(52) U.S. Cl. 414/540; 414/921

(57) ABSTRACT

In a preferred embodiment, the present invention incorporates a fluid pressure sensing switch in fluid communication with a hydraulic fluid outlet of a hydraulic pump driving a platform lift. The pressure switch is calibrated to activate at a pump outlet pressure created when the pump attempts to lift (fold) the platform into the stow position when it carries a load. The switch is calibrated not to activate at a pump outlet pressure created when the pump attempts to lift (fold) the platform into the stow position when the platform is unloaded. Activation of the pressure switch disables the hydraulic pump, thereby preventing a loaded platform from being folded into the stow position.

### CROSS-REFERENCE TO RELATED APPLICATIONS

The present application claims priority benefit from U.S. Provisional Patent Application Ser. No. 60/106,365, filed Oct. 30, 1998, the disclosure of which is incorporated herein by reference in its entirety.

### TECHNICAL FIELD IN THE INVENTION

The present invention generally relates to hydraulic lifts and, more particularly, to a pressure switch to defeat platform fold operation in a hydraulic lift.

### BACKGROUND OF THE INVENTION

Hydraulic lifts, such as dual parallel arm hydraulic lifts, for example, are well known in the art. A typical dual parallel arm hydraulic lift is illustrated in FIG. 1 and indicated generally at 1. Such lifts are typically employed at the doorways 2 of passenger vehicles 3 in order to lift persons in wheelchairs from a down position at ground level to a floor level of the vehicle 3 which allows ingress and egress to and from the vehicle 3. After such a lift 1 has been used, a fold operation is implemented to fold the lift platform 4 to a vertical, or stowed, position, where it rests just inside the vehicle door 2. Such lifts 1 have complete hydraulic function, in that the lift 1 is moved from ground level to floor level of the vehicle 3 by retracting (or expanding) hydraulic actuating mechanisms (such as hydraulic cylinders 5 and 6) with hydraulic pressure. Further retraction (or expansion) of the lifting cylinders 5, 6 causes the platform to fold into the stowed position.

The Federal Transit Administration (FTA) of the United States Government requires that a means be provided to disable the hydraulic system from folding the lift platform 4 into the stowed position if the platform 4 is occupied. The common practice in the prior art has been to provide a flexing arm with a mechanical switch (not shown) that activates if the platform 4 starts to fold when the platform 4 is occupied. This method has proved to be ineffective due to variations of how the mechanical arm is set, the amount and rate of deformation of the flex arm material, and physical damage to the switch and/or wiring running through the lift mechanism with use.

A more effective and reliable method for disabling the fold operation of a hydraulic lift platform when the platform is occupied is therefore required. A solution to this problem has thus far eluded those skilled in the art.

### BRIEF DESCRIPTION OF THE DRAWINGS

FIG. 1 is a perspective view of a prior art hydraulic platform lift.

FIG. 2 is a perspective view of a pressure switch of the present invention installed onto a hydraulic pump unit of a prior art dual parallel arm lift.

FIG. 3 is a second perspective view of the pressure switch of FIG. 2.

FIG. 4 is a hydraulic schematic diagram of the dual parallel arm lift of FIG. 1, showing the mounting location for the pressure switch of the present invention.

### SUMMARY OF THE INVENTION

In a preferred embodiment, the present invention incorporates a fluid pressure sensing switch in fluid communication with a hydraulic fluid outlet of a hydraulic pump driving a platform lift. The pressure switch is calibrated to activate at a pump outlet pressure created when the pump attempts to lift (fold) the platform into the stow position when it carries a load. The switch is calibrated not to activate at a pump outlet pressure created when the pump attempts to lift (fold) the platform into the stow position when the platform is unloaded. Activation of the pressure switch disables the hydraulic pump, thereby preventing a loaded platform from being folded into the stow position.

In one form of the present invention, a hydraulic lift coupled to a vehicle is disclosed, the hydraulic lift comprising a platform for carrying a load; at least one hydraulic actuating mechanism coupled to said platform and operable to move said platform from a ground level to a vehicle level, and further operable to fold said platform into a substantially vertical stow position; a hydraulic pump having a pump outlet coupled to said at least one hydraulic actuating mechanism for providing a pressurized hydraulic fluid thereto; and a pressure switch having first and second electrical terminals and a fluid pressure input, said pressure switch operative to electrically couple the first and second electrical terminals when a pressure sensed by the fluid pressure input is on one side of a predetermined threshold and further operable to electrically uncouple the first and second electrical terminals when the pressure sensed by the fluid pressure input is on another side of the predetermined threshold; wherein the fluid pressure input is operatively coupled to the pump outlet for sensing a pressure of the hydraulic fluid; and wherein the first and second electrical terminals are operatively coupled to a source of electrical energy supplied to said pump, such that said pump is enabled and disabled depending upon whether the first and second electrical terminals are electrically coupled.

In another form of the present invention, a hydraulic lift coupled to a vehicle is disclosed, the hydraulic lift comprising a platform for carrying a load; at least one hydraulic actuating mechanism coupled to said platform and operable to move said platform from a ground level to a vehicle level, and further operable to fold said platform into a substantially vertical stow position; a hydraulic pump having a pump outlet coupled to said at least one hydraulic actuating mechanism for providing a pressurized hydraulic fluid thereto; a control system operatively coupled to the hydraulic pump for enabling and disabling operation of the lift; and a pressure switch having first and second electrical terminals and a fluid pressure input, said pressure switch operative to electrically couple the first and second electrical terminals when a pressure sensed by the fluid pressure input is on one side of a predetermined threshold and further operable to electrically uncouple the first and second electrical terminals when the pressure sensed by the fluid pressure input is on another side of the predetermined threshold; wherein the fluid pressure input is operatively coupled to the pump outlet for sensing a pressure of the hydraulic fluid; and wherein the first and second electrical terminals are operatively coupled to said control system such that the lift is prevented from folding said platform into the stow position when the pressure sensed by the fluid pressure input exceeds the predetermined threshold.

In yet another form of the present invention, a method of controlling a hydraulic platform lift operable to utilize a pressurized hydraulic fluid to move a platform from a lowered position to an elevated position, and further operable to fold the platform into a substantially vertical stowed position is disclosed, comprising the steps of a) sensing a pressure of the hydraulic fluid; b) determining if the sensed pressure is greater than a predetermined threshold; and c) preventing the platform from being folded into the stowed position if the sensed pressure is greater than the predetermined threshold.

### DETAILED DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

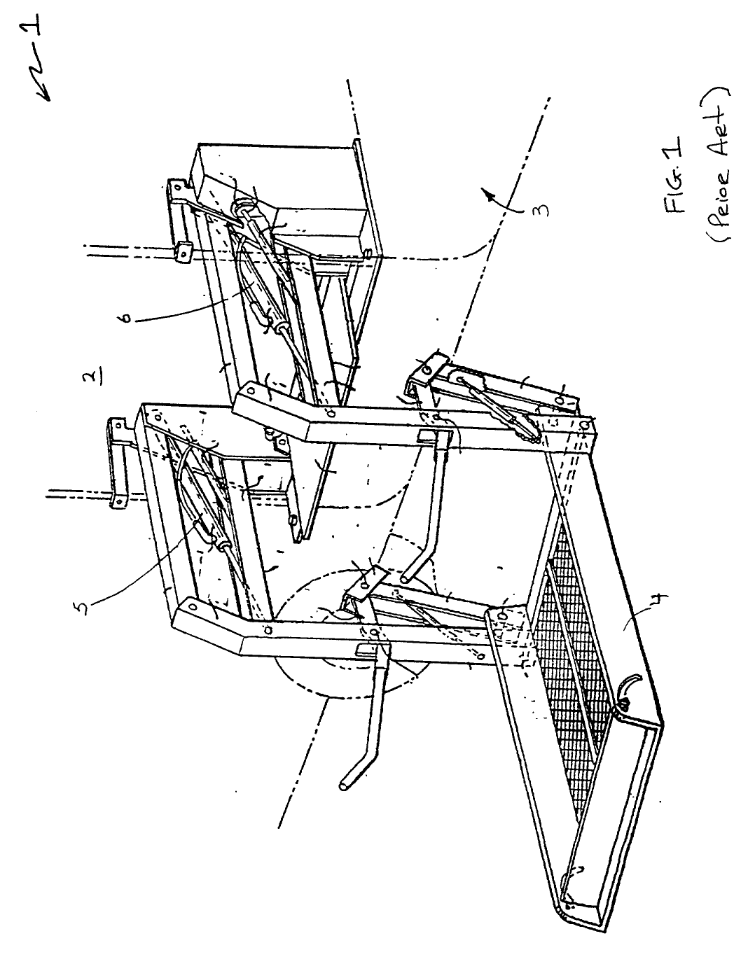

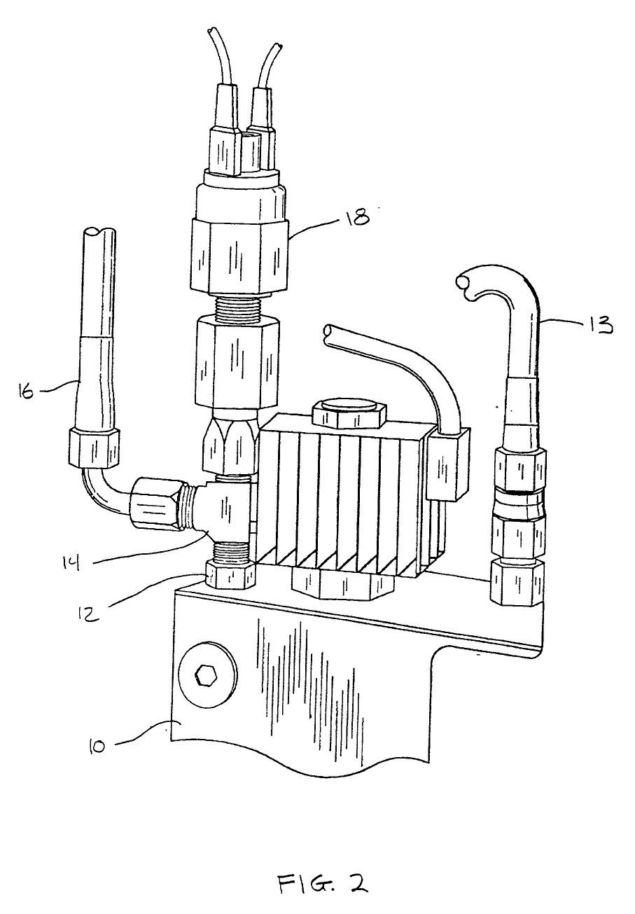

The present invention prevents operation of the fold function of a hydraulic lift by incorporating a pressure switch into the hydraulic and electric circuit of the lift in order to provide a positive safeguard. As illustrated in FIG. 2, a hydraulic pump 10 is illustrated, wherein the pump 10 is employed to move a hydraulic lift (such as the lift 1 of FIG. 1, for example) from a ground level to a vehicle level to a stowed position by pumping hydraulic fluid out of a pump outlet 12, as is known in the art. In prior art devices, the hydraulic fluid pumped from the pump outlet 12 is applied to one or more hydraulic actuating mechanisms, such as a hydraulic cylinder, to cause movement of the lift. Hydraulic fluid is supplied to the pump 10 from a reservoir (not shown) via the hydraulic fluid input line 13. In the present invention, a T-fitting 14 is installed at the hydraulic fluid output port 12 of the hydraulic pump 10 in order to provide coupling points for the normal hydraulic fluid output line 16 (coupled to the hydraulic actuating mechanisms) and the pressure switch 18 of the present invention. Thus situated, the pressure switch 18 senses hydraulic pump 10 pressure directly at the pump outlet 12. Hence, when the fold electric circuit activates the pump 10, the pressure switch 18 is part of that circuit. If the pump 10 outlet 12 pressure is above a minimum pressure required to fold the lift platform, the pressure switch 18 is operable to electronically shut off the hydraulic pump 10, thereby disabling the lift fold function. This system eliminates the variables which cause the prior art mechanical flex arm to be ineffective.

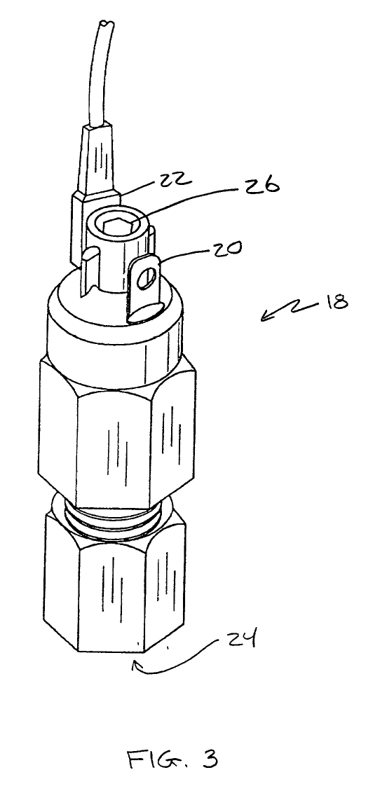

Referring now to FIG. 3, the pressure switch 18 is preferably a single pole, single throw (SPST) switch having two terminals 20 and 22 (a wire is shown coupled to terminal 22 in FIG. 3). An electrical connection is made or broken between the terminals 20 and 22, depending upon whether a fluid pressure appearing at the switch fluid pressure input port 24 is above or below a predetermined threshold level. The present invention comprehends that the switch 18 may be designed to make the electrical connection in response to the occurrence of either pressure condition and to break the electrical connection in response to the occurrence of the other pressure condition. This predetermined threshold pressure level is preferably adjustable by rotation of an adjustment screw 26.

The amount of pump 10 outlet pressure that is required to lift the unloaded platform varies from lift to lift according to the lift design, the individual resistance of the lift pivot points, etc. As discussed hereinabove, the pressure switch 18 has a calibratable trip pressure which may be adjusted by means of the screw 26 located on its upper surface. When the lift is manufactured, the switch 18 is set to a point where it will not allow the pump 10 to develop enough pressure to fold the lift to the stow position when the platform is empty (unoccupied). The screw 26 is then moved in one-quarter turn increments (corresponding to approximately a 100 PSI increase) until the pressure developed by the pump 10 is high enough to fold the lift platform to the stow position without any hesitation. The screw 26 is then preferably turned an additional one-quarter turn and then left in this position during subsequent operation of the lift. The pressure switch 18 has thus been set to a predetermined threshold trip pressure which will cause the switch 18 to trip when any appreciable weight is placed on the lift platform. Whenever the switch 18 trips, it is electrically connected into the control system of the hydraulic lift in such a way that the lift is disabled, thereby preventing the lift from executing the fold operation when the lift platform is loaded. In a preferred embodiment, tripping of the pressure switch 18 operates to disconnect the pump 10 from its source of power.

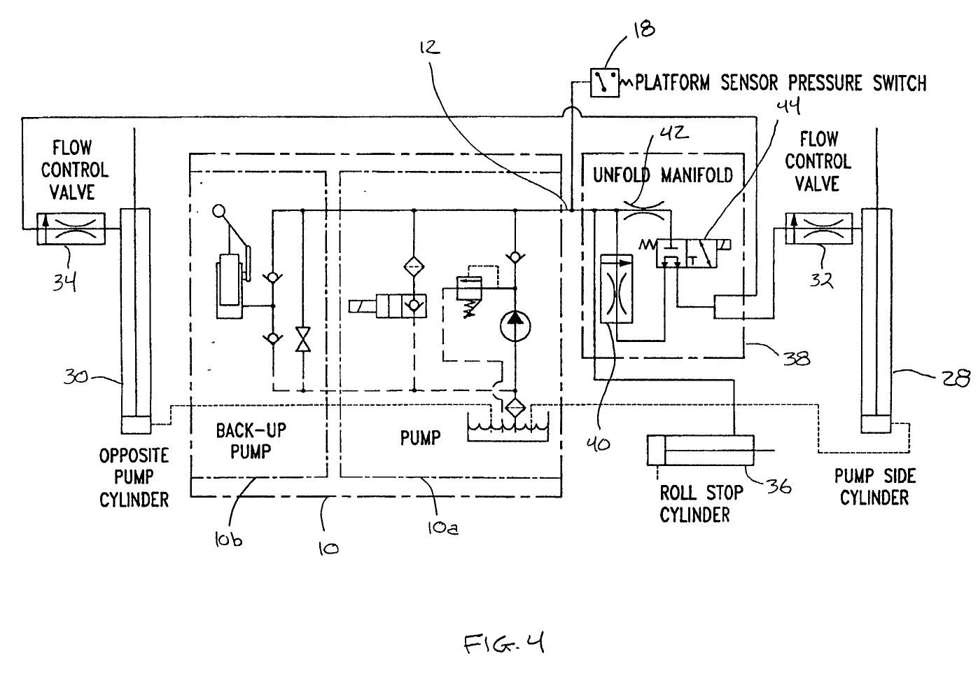

Referring now to FIG. 4, a preferred integration location of the pressure switch 18 into a typical hydraulic platform lift is illustrated schematically. The lift platform is raised and lowered by means of two hydraulic cylinders 28 and 30 supplied with hydraulic fluid from the pump 10 through respective pressure compensated flow control valves 32 and 34. Typically, pump 10 comprises an electric pump 10a and an emergency manual pump 10b. A roll stop activation cylinder 36 is driven from the pump 10 outlet port 12 in order to activate a platform roll stop, as is known in the art. The pump 10 outlet 12 is further coupled to an unfold manifold 38, which supplies pressurized hydraulic fluid to the flow control valves 32 and 34. The unfold manifold 38 preferably incorporates a flow control valve 40, an unfold orifice 42, and a three-way two-position solenoid valve 44. The pressure switch 18 is coupled to sense the hydraulic fluid pressure between the pump 10 and the unfold manifold 38. A pressure high enough to trip the pressure switch 18 will preferably interrupt power to the pump 10, thereby disabling the pump 10.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed:

1. A hydraulic lift coupled to a vehicle, the hydraulic lift comprising:
a platform for carrying a load;
at least one hydraulic actuating mechanism coupled to said platform and operable to move said platform from a ground level to a vehicle level, and further operable to fold said platform into a substantially vertical stow position;
a hydraulic pump having a pump outlet coupled to said at least one hydraulic actuating mechanism for providing a pressurized hydraulic fluid thereto; and
a pressure switch having first and second electrical terminals and a fluid pressure input, said pressure switch operative to electrically couple the first and second electrical terminals when a pressure sensed by the fluid pressure input is on one side of a predetermined threshold and further operable to electrically uncouple the first and second electrical terminals when the pressure sensed by the fluid pressure input is on another side of the predetermined threshold;
wherein the fluid pressure input is operatively coupled to the pump outlet for sensing a pressure of the hydraulic fluid; and
wherein the first and second electrical terminals are operatively coupled to a source of electrical energy supplied to said pump, such that said pump is enabled and disabled depending upon whether the first and second electrical terminals are electrically coupled.

2. The hydraulic lift of claim 1, wherein the hydraulic lift comprises a dual parallel arm lift.

3. The hydraulic lift of claim 1, wherein said at least one hydraulic actuating mechanism comprises a pair of hydraulic cylinders.

4. The hydraulic lift of claim 1, wherein the predetermined threshold is calibratable.

5. The hydraulic lift of claim 4, wherein said pressure switch further comprises an adjustment screw, wherein the predetermined threshold is calibrated by turning the adjustment screw.

6. The hydraulic lift of claim 1, further comprising:
a T-fitting having a first port coupled to the pump outlet, a second port operatively coupled to said at least one hydraulic actuating mechanism, and a third port operatively coupled to the fluid pressure input of said pressure switch.

7. A hydraulic lift coupled to a vehicle, the hydraulic lift comprising:
a platform for carrying a load;
at least one hydraulic actuating mechanism coupled to said platform and operable to move said platform from a ground level to a vehicle level, and further operable to fold said platform into a substantially vertical stow position;
a hydraulic pump having a pump outlet coupled to said at least one hydraulic actuating mechanism for providing a pressurized hydraulic fluid thereto;
a control system operatively coupled to the hydraulic pump for enabling and disabling operation of the lift; and
a pressure switch having first and second electrical terminals and a fluid pressure input, said pressure switch operative to electrically couple the first and second electrical terminals when a pressure sensed by the fluid pressure input is on one side of a predetermined threshold and further operable to electrically uncouple the first and second electrical terminals when the pressure sensed by the fluid pressure input is on another side of the predetermined threshold;
wherein the fluid pressure input is operatively coupled to the pump outlet for sensing a pressure of the hydraulic fluid; and
wherein the first and second electrical terminals are operatively coupled to said control system such that the lift is prevented from folding said platform into the stow position when the pressure sensed by the fluid pressure input exceeds the predetermined threshold.

8. The hydraulic lift of claim 7, wherein the hydraulic lift comprises a dual parallel arm lift.

9. The hydraulic lift of claim 7, wherein said at least one hydraulic actuating mechanism comprises a pair of hydraulic cylinders.

10. The hydraulic lift of claim 7, wherein the predetermined threshold is calibratable.

11. The hydraulic lift of claim 10, wherein said pressure switch further comprises an adjustment screw, wherein the predetermined threshold is calibrated by turning the adjustment screw.

12. The hydraulic lift of claim 7, further comprising:
a T-fitting having a first port coupled to the pump outlet, a second port operatively coupled to said at least one hydraulic actuating mechanism, and a third port operatively coupled to the fluid pressure input of said pressure switch.

13. A method of controlling a hydraulic platform lift operable to utilize a pressurized hydraulic fluid to move a platform from a lowered position to an elevated position, and further operable to fold the platform into a substantially vertical stowed position, comprising the steps of:
a) sensing a pressure of the hydraulic fluid;
b) determining if the sensed pressure is greater than a predetermined threshold; and
c) preventing the platform from being folded into the stowed position if the sensed pressure is greater than the predetermined threshold.

14. The method of claim 13, wherein the predetermined threshold corresponds to a pressure produced by the platform when carrying a load.

15. The method of claim 13, wherein step (c) further comprises tripping a switch coupled to a control system of the lift if the sensed pressure is greater than the predetermined threshold.
